(19) United States
(12) Patent Application Publication
(10) Pub. No.: US 2014/0240031 A1
(43) Pub. Date: Aug. 28, 2014

(54) SYSTEM AND METHOD FOR TUNING A THERMAL STRATEGY IN A PORTABLE COMPUTING DEVICE BASED ON LOCATION

(71) Applicant: QUALCOMM INCORPORATED, San Diego, CA (US)

(72) Inventors: Unnikrishnan Vadakkanmaruveedu, Phoenix, AZ (US); Paras S. Doshi, San Diego, CA (US); Ankur Jain, San Diego, CA (US); Priyank Kumar, San Diego, CA (US); Vinay Mitter, San Diego, CA (US); Richard A. Stewart, San Diego, CA (US)

(73) Assignee: QUALCOMM Incorporated, San Diego, CA (US)

(21) Appl. No.: 13/779,606

(22) Filed: Feb. 27, 2013

(51) Int. Cl. G05D 23/20

(52) U.S. Cl. CPC G05D 23/20
USPC 327/512

(57) ABSTRACT

Various embodiments of methods and systems for tuning a thermal strategy of a portable computing device (“PCD”) based on PCD location information. In an exemplary embodiment, it may be recognized that the PCD is in an active state and producing thermal energy, or that one or more thermally aggressive components of the PCD are operating near temperature thresholds for efficient operation. The PCD location information is used to estimate the environmental ambient temperature to which the PCD is exposed. Certain embodiments may simply render the estimated ambient temperature for the benefit of the user or may use the estimated ambient temperature as an input to a program, application, or algorithm running on the PCD. It is envisioned that certain embodiments of the systems and methods may use the estimated ambient temperature to adjust temperature thresholds in the PCD against which thermal management policies govern thermally aggressive PCD components.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

One unique aspect of PCDs is that they typically do not have active cooling devices, like fans, which are often found in larger computing devices such as laptop and desktop computers. Instead of using fans, PCDs may rely on the spatial arrangement of electronic packaging so that two or more active and heat producing components are not positioned proximally to one another. Many PCDs may also rely on passive cooling devices, such as heat sinks, to manage thermal energy among the electronic components which collectively form a respective PCD.

PCDs are typically limited in size and, therefore, room for components within a PCD often comes at a premium. As such, there usually isn't enough space within a PCD for engineers and designers to mitigate thermal degradation or failure of processing components by using clever spatial arrangements or strategic placement of passive cooling components. Therefore, some current systems and methods rely on various temperature sensors embedded on the PCD chip to monitor the dissipation of thermal energy and then use the measurements to trigger application of thermal management techniques that adjust workload allocations, processing speeds, etc. to reduce thermal energy generation and mitigate thermal degradation.

The temperature measurements taken near thermal energy generating components within a PCD are just one potentially relevant input for a given thermal management technique. For instance, if the environmental ambient temperature can be accurately measured or estimated (i.e., the temperature to which the entire PCD is exposed), certain temperature thresholds monitored within a PCD may be adjusted such that applied thermal management techniques serve to optimize PCD performance and provide a high quality of service (“QoS”) level to a user. However, given the number of potential heat sources in a PCD, especially when it is being actively used, it is difficult to accurately and reliably determine the temperature of the ambient temperature surrounding the PCD, using sensors within the PCD. Such sensors may also add to the cost and size of the PCD.

Given the difficulty in measuring the ambient temperature of a PCD, thermal mitigation strategies employed by PCDs often assume an ambient temperature equal to standard room temperature between 20° C. and 30° C. However, this means that thermal mitigation decisions made when this assumption is wrong (such as when a PCD is being used outside in extremely cold or extremely hot weather) can lead to under-performance of the device and/or will not be effective to control or account for any sudden ramp up in temperature.

Therefore, what is needed in the art is a system and method for more accurately estimating the environmental ambient temperature to which a PCD is exposed. Further, there is also a need in the art for a system and method for using an estimated environmental ambient temperature to which a PCD is exposed as an input for a thermal management algorithm.

### SUMMARY OF THE DISCLOSURE

Various embodiments of methods and systems for tuning a thermal strategy of a portable computing device (“PCD”) based on PCD location information. In an exemplary embodiment, parameters associated with various components or subsystems in the PCD and indicative of processing activity are monitored. Based on the monitoring of those parameters, an active state qualifier scenario or event may be recognized, i.e. it may be recognized that the various components or subsystems are consuming power and, thus, producing thermal energy. Recognition of the active state qualifier determines that the PCD is in an active state.

When the PCD is determined to be in an active state, information for estimating the ambient temperature in which the PCD is operating is gathered from available sources based on the location of the PCD. This PCD location information may include information based on the Global Positioning System (GPS) information about the PCD, such as temperature information from the National Oceanic and Atmospheric Administration (NOAA) or other weather service based on the GPS coordinates of the PCD, information about the strength of a GPS signal received by the PCD, whether GPS coordinates for the PCD can be determined to be inside a building, as well as other location-based sources of information about the PCD. Subsequently, based on part of (or all) of the available PCD location information, an ambient temperature is estimated.

Certain embodiments may simply render the estimated ambient temperature for the benefit of the user or use the estimated ambient temperature as an input to a program or application running on the PCD. It is envisioned that certain embodiments of the systems and methods may use the estimated ambient temperature to adjust temperature thresholds in the PCD (including temperature thresholds for one or more components or cores in the PCD) against which thermal management policies govern thermally aggressive processing components.

For instance, based on an estimated ambient temperature that is below a certain value or relatively cooler than a previous estimation, certain embodiments may increase the thermal threshold associated with the skin temperature of the PCD. Similarly, other embodiments may recognize the increased efficiency for thermal energy dissipation into the cooler ambient environment and allow thermally aggressive components within the PCD to run at relatively higher thermal thresholds, such as at higher processing speeds. Because the PCD is determined to be exposed to a cooler ambient environment, dissipation of excess thermal energy may be more efficient to such an extent that an increase in the skin temperature of the PCD will not significantly affect the user experience.

In another example, based on an estimated ambient temperature that is higher than a certain value, or relatively warmer than a previous estimation, certain embodiments may decrease the thermal threshold associated with the skin temperature of the PCD. Similarly, other embodiments may recognize the decreased efficiency of thermal energy dissipation into the warmer ambient environment and may throttle thermally aggressive components within the PCD to run at relatively lower thermal thresholds, such by forcing thermally aggressive components to operate at lower processing speeds, or by removing tasks from thermally aggressive components and re-routing such tasks to less thermally aggressive components or components that are farther away from their thermal threshold.

Advantageously, therefore, by recognizing the cooler or warmer ambient environment and adjusting the temperature threshold, as well as other operating parameters, accordingly, embodiments of the systems and methods may provide for a more accurate and efficient thermal mitigation strategy for thermally aggressive processing components.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a functional block diagram illustrating an embodiment of an on-chip system for estimating environmental ambient temperature from PCD location information and using the estimation as an input to a thermal management technique;

FIG. 2 is a functional block diagram illustrating an exemplary, non-limiting aspect of the PCD of FIG. 1 in the form of a wireless telephone for implementing methods and systems for estimating environmental ambient temperature from PCD location information and using the estimation as an input to a thermal management technique;

FIG. 3A is a functional block diagram illustrating an exemplary spatial arrangement of hardware for the chip illustrated in FIG. 2;

FIG. 3B is a schematic diagram illustrating an exemplary software architecture of the PCD of FIG. 2 for estimating environmental ambient temperature from PCD location information and using the estimation as an input to a thermal management technique;

FIG. 4 is a logical flowchart illustrating a method for estimating environmental ambient temperature from PCD location information of FIG. 1 and using the estimation as an input to a thermal management technique; and

FIG. 5 is a logical flowchart illustrating a sub-method or subroutine for applying dynamic voltage and frequency scaling (“DVFS”) thermal mitigation techniques that use temperature thresholds adjusted based on an estimated environmental ambient temperature.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system” and the like are intended to refer to a computer-related entity, either hardware, firmware, a combination of hardware and software, software, or software in execution and represent exemplary means for providing the functionality and performing the certain steps in the processes or process flows described in this specification. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or a chip may be comprised of one or more distinct processing components generally referred to herein as “core(s).”

In this description, it will be understood that the terms “thermal” and “thermal energy” may be used in association with a device or component capable of generating or dissipating energy that can be measured in units of “temperature.” Consequently, it will further be understood that the term “temperature,” with reference to some standard value, envisions any measurement that may be indicative of the relative warmth, or absence of heat, of a “thermal energy” generating device or component. For example, the “temperature” of two components is the same when the two components are in “thermal” equilibrium.

It will also be understood that the term “ambient temperature,” with reference to some standard value, is used in this description to refer to the measurement of the relative warmth, or absence of heat, of the environment to which a PCD is exposed. For example, the “ambient temperature” of a PCD when the PCD is sitting on a desk in a user's air conditioned office may be around sixty eight degrees Fahrenheit (68° F.). The “ambient temperature” of the same PCD may become around ninety degrees Fahrenheit (90° F.) when the user picks up the PCD and takes it outdoors of his office building during the day in the month of August, or around thirty degrees Fahrenheit (30° F.) when the user picks up the PCD and takes it outdoors of the same office building during the evening in the month of February. As such, one of ordinary skill in the art will understand that the “ambient temperature” of a PCD is not affected by the PCD itself but may change with the physical location of the PCD, as well as time of day and/or time of year.

In this description, the terms “skin temperature” and “outer shell temperature” and the like are used interchangeably to refer to a temperature associated with the outer shell or cover aspect of a PCD. As one of ordinary skill in the art would understand, the skin temperature of a PCD may be associated with a sensory experience of the user when the user is in physical contact with the PCD.

In this description, the terms “workload,” “process load” and “process workload” are used interchangeably and generally directed toward the processing burden, or percentage of processing burden, associated with a given processing component in a given embodiment. Further to that which is defined above, a “processing component” or “thermal energy generating component” or “thermal aggressor” may be, but is not limited to, a central processing unit, a graphical processing unit, a core, a main core, a sub-core, a processing area, a hardware engine, etc. or any component residing within, or external to, an integrated circuit within a portable computing device.

In this description, the terms “thermal mitigation technique(s),” “thermal policies,” “thermal management,” “thermal mitigation measure(s) and the like are used interchangeably. Notably, one of ordinary skill in the art will recognize that, depending on the particular context of use, any of the terms listed in this paragraph may serve to describe hardware and/or software operable to increase performance at the expense of thermal energy generation, decrease thermal energy generation at the expense of performance, or alternate between such goals.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

In portable computing devices, the tight spatial arrangement of thermally aggressive components lends to excessive amounts of heat being produced when those components are asked to process workloads at high performance levels. In many cases, the temperature threshold of the outer surface of the PCD, i.e. the “skin temperature,” is the limiting factor in just how much thermal energy the components within the PCD are allowed to produce. Notably, the skin temperature threshold is often dictated by the maximum temperature to which a user may be exposed and not the maximum temperature to which the components themselves may be exposed. That is, the user experience as measured by the skin temperature of the PCD is often the factor from which a thermal mitigation algorithm determines that the processing performance of components within the PCD must be dialed back.

The skin temperature threshold in a PCD is often preset and fixed, even though the user experience when exposed to a certain skin temperature varies depending on the ambient temperature of the environment. For instance, a PCD with a 55° C. skin temperature may adversely impact the user experience when the user is in a climate controlled office but wouldn't be noticed by the same user when the user is standing outdoors in a snow flurry. That is, one of ordinary skill in the art will recognize that thermal energy generated by thermally aggressive processing components in a PCD may be dissipated more efficiently when the PCD is exposed to a relatively cooler ambient environment and, as such, the processing components within the PCD may be run at processing higher frequencies in some scenarios where it is recognized that the PCD is exposed to cooler ambient temperatures. For this reason, in exemplary embodiments of the systems and methods disclosed herein the estimated ambient temperature of a PCD may be a dynamic input to a thermal mitigation algorithm that uses the input to drive decisions whether or not to implement and/or adjust the application of one or more thermal mitigation techniques.

Embodiments of the systems and methods may raise or lower the preset temperature threshold of the PCD based on ambient temperature estimations. As the temperature threshold is adjusted, the performance levels of the processing components within the PCD may also be adjusted to optimize QoS. Exemplary embodiments estimate the ambient temperature of the environment in which the PCD resides by gathering location information for the PCD, such as GPS coordinates for the PCD and additional information associated with those GPS coordinates.

Notably, thermally aggressive components and subsystems in a PCD generate thermal energy when actively processing workloads. As such, some embodiments coordinate the timing of temperature measurements from sensors within the PCD with active periods or the recognition of active state qualifiers of the thermally aggressive components or subsystems in the PCD. Such active periods or the recognition of active state qualifiers may be identified by monitoring temperature sensors associated with thermal energy generating components or subsystems in the PCD.

Exemplary active state qualifiers that may be recognized by certain embodiments include, but are not limited to, an active video display, active battery charging cycle, current levels on a power rail, CPU frequencies, etc.—essentially, an active state qualifier may be any indication that a given thermally aggressive component or thermally aggressive activity in the PCD is actively generating thermal energy. Once an active state qualifier, or combination of active state qualifiers, is recognized, certain embodiments may begin or increase frequency of ambient temperature estimations for an “active period.” It is envisioned that the duration of an active period may be preset in certain exemplary embodiments, however, it is also envisioned that active periods may be variable in duration and based on a trend of temperature measurements that indicate that the thermal energy level in the active area(s) of the PCD have, or have not, stabilized.

To recognize an active state, it is envisioned that certain embodiments will monitor and compare the activity levels of components or subsystems within the PCD which are unrelated in functionality. In this way, an accurate identification of an overall active state of the PCD may be attained. If all systems monitored are “on” then exemplary embodiments may determine that the PCD is in an active state. As a non-limiting example, an exemplary embodiment may monitor the graphics processing unit (“GPU”), the power management integrated circuit (“PMIC”) and the radio frequency (“RF”) transceiver. Because few use case scenarios of the PCD would dictate that the GPU, PMIC and RF transceiver be active at the same time, recognition that each of the systems is “on” may be a valid active state qualifier and/or may warrant more frequent ambient temperature estimations.

In some embodiments, an active state qualifier may be recognized by one or more components or subsystems of the PCD approaching a thermal threshold value, as measured by temperature sensor associated with the active component or subsystem. Notably, it is envisioned that the temperature sensor may be any temperature sensor within the PCD including, but not limited to, a sensor associated with a processing core, a sensor associated with a memory component, a sensor associated with the skin (i.e., outer shell) aspect of the PCD, etc. In this way, as one or more component or subsystem of the PCD is recognized as approaching thermal threshold value (whether the threshold value has been set by the PCD or established by the component manufacturer) ambient temperature estimations may begin, or may be increased in frequency to evaluate the potential increased need for implementation of a thermal mitigation strategy.

Once estimated, embodiments of the systems and methods may use the estimated ambient temperature as an input to a thermal mitigation algorithm. One example is to use the estimated ambient temperature to adjust the acceptable thermal threshold value for a component or subsystem of the PCD. It is envisioned, however, that other embodiments may use the estimated ambient temperature for other purposes. Such other purposes may include, but are not limited to, display for the benefit of the user, an input to an application such as a weather application, etc.

Exemplary embodiments are described herein relative to using the estimated ambient temperature as an input to adjust temperature thresholds associated with various processing components. It is also envisioned that certain embodiments may leverage the estimated ambient temperature to adjust other temperature related thresholds within the PCD including, but not limited to, a skin temperature threshold. For embodiments that adjust the acceptable skin temperature threshold based on the estimated ambient temperature of the PCD, the adjustment of the skin temperature threshold may be driven by user perception, as opposed to concern for the actual temperature of the outer shell aspect of the PCD.

As described above, exposure to a change in environmental ambient temperature directly impacts the efficiency of the PCD to dissipate excess thermal energy. As such, one of ordinary skill in the art would recognize that exposure to a lower ambient temperature would facilitate more efficient dissipation of thermal energy from the PCD, and vice versa. Recognizing this reality, embodiments may take advantage of a lowered estimation of environmental ambient temperature. For example for an estimation of a lower environmental ambient temperature, some embodiments may allow short bursts of processing load that would otherwise be prevented to avoid the generation of excess thermal energy that may adversely affect user experience.

Some embodiments may adjust the acceptable temperature or thermal threshold of PCD components or subsystems based on the estimated ambient temperature of the PCD. For such embodiments, the adjustment of temperature or thermal threshold may be driven by a goal of optimizing the allowable temperature thresholds in view of original equipment manufacturer (“OEM”) specification limits. For example, an OEM specification limit for a PCD skin temperature may be the lesser of 55° C. and 20° C. above ambient. In such a scenario, when the estimated ambient temperature increases from 25° C. to 35° C., for example, the maximum allowed skin temperature threshold would be 55° C., as opposed to 45° C. Recognizing this, certain embodiments may leverage the specification limit change in view of the estimated ambient temperature to take advantage of the extra thermal headroom. Similar advantages may be obtained for other components or subsystems of the PCD with OEM operating temperature limitations.

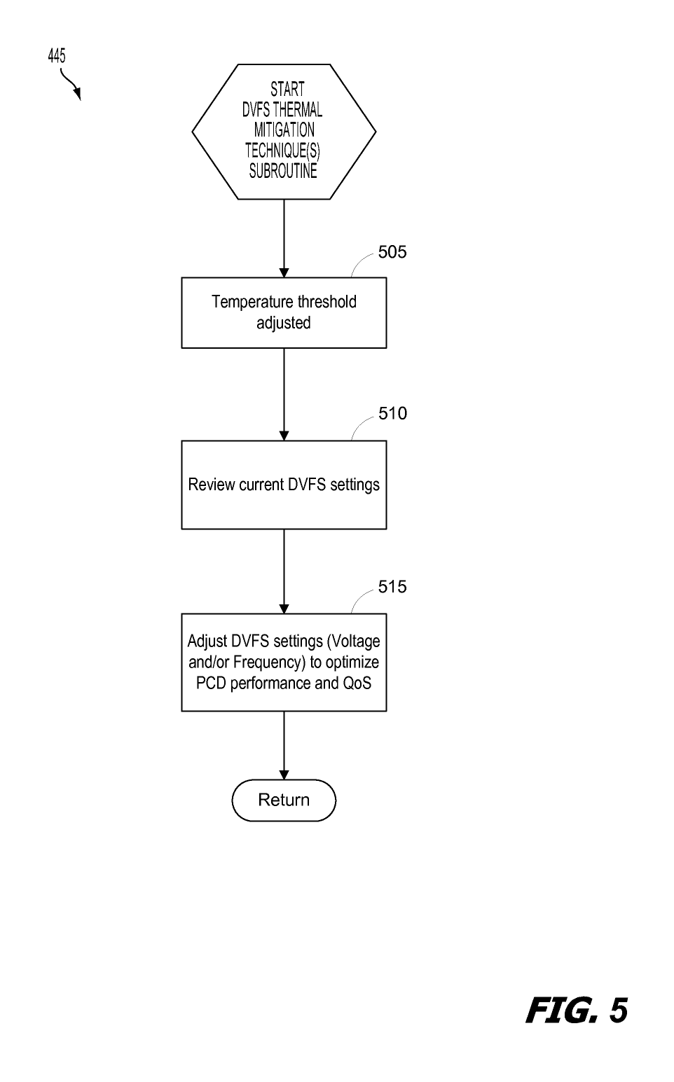

As one of ordinary skill in the art would recognize, an adjustment of a temperature threshold based on an estimated ambient temperature, may cause a thermal management algorithm to leverage means for throttling a component or core up or down to an optimum performance level. As more specifically described below, throttling strategies are various methods, applications and/or algorithms that may be employed by the PCD to increase its performance through adjustment of hardware and/or software parameters, such as the clock speed of a central processing unit (“CPU”) or the like. Certain throttling strategies may increase performance of a PCD at the expense of increased thermal energy generation; however, certain other throttling strategies may mitigate a detrimental rise in operating temperature by reducing PCD performance. An exemplary throttling method that may be used by embodiments of the systems and methods is a dynamic voltage and frequency scaling (“DVFS”) method, described in more detail relative to FIG. 5.

Even though the various exemplary embodiments described in this specification utilize throttling methodologies, such as DVFS, to manage thermal energy generation by a thermally aggressive processing component, it is envisioned that systems and methods will not be limited to using throttling techniques in an effort to optimize performance in light of a temperature threshold that has been adjusted based on an ambient temperature measurement. That is, it is envisioned that some embodiments may additionally, or exclusively, leverage operating system level thermal mitigation techniques such as, but not limited to, workload shifting techniques.

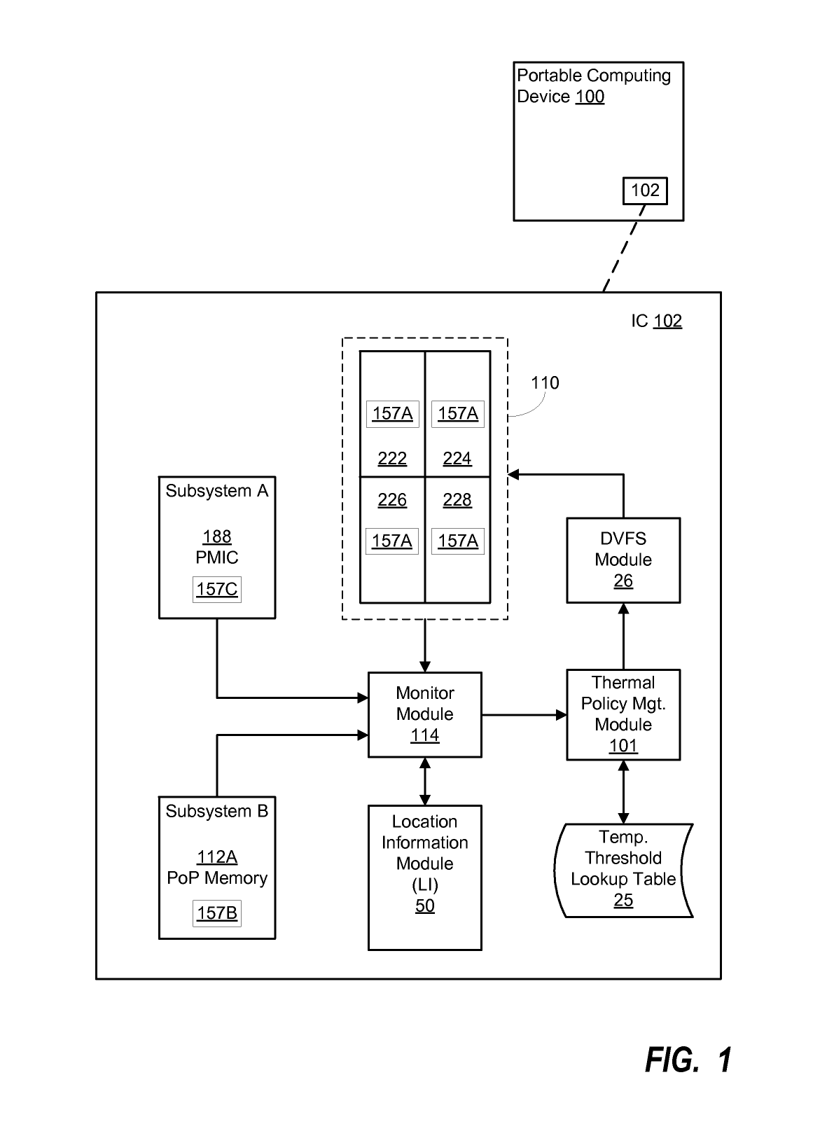

FIG. 1 is a functional block diagram illustrating an embodiment of an on-chip system 102 for estimating environmental ambient temperature for a portable computing device (“PCD”) 100 and using the estimation as an input to a thermal management technique. To monitor operating temperatures against maximum allowed temperature thresholds, the on-chip system 102 may employ various sensors 157 for measuring temperatures associated with various components such as cores 222, 224, 226, 228, package-on-package (“PoP”) memory 112A and PCD outer shell. Advantageously, by monitoring the temperatures associated with the various components and incrementally throttling the performance levels of thermal aggressors 222, 224, 226, 228 based on maximum allowed temperature thresholds, the QoS experienced by a user of the PCD 100 may be optimized by throttling performance only as much as necessary.

In general, the exemplary system employs four main modules: (1) a monitor module 114 for recognizing an active state qualifier and monitoring temperature measurements from sensors 157; (2) a location information (“LI”) module 50 for gathering location information about the PCD 100, estimating environmental ambient temperature based on that location information, and forwarding the estimated environmental ambient temperature to the monitor module 114; (3) a thermal policy management (“TPM”) module 101 for receiving the ambient temperature estimation from the monitor module 114, adjusting temperature thresholds based on the ambient temperature estimation and directing thermal mitigation techniques; and (4) a DVFS module 26 for implementing throttling strategies on individual processing components according to instructions received from TPM module 101.

Note that in some embodiments the functionality of two or more of the modules listed above may be combined into a single module, such that there are three, two, or a single module instead of four separate modules. For example, monitor module 114 and TPM module 101 may be one and the same in some embodiments. Similarly, in some embodiments functionality ascribed above to one module may be performed by a different module. For example, the LI module 50 may gather the location information and forward to the monitor module 114 to perform the estimation of the environmental ambient temperature, rather than the LI module 50 performing the estimation as described above.

Advantageously, embodiments of the system and method that include the four main modules utilize location information to estimate the ambient temperature of the environment to which the PCD 100 is exposed. This PCD location information may then be used in some embodiments to optimize the performance level for components 110 within the PCD 100. One exemplary way in the PCD location information may be use is to adjust temperature thresholds that are affected by the ambient temperature exposure. PCD location information may include information based on, or derived from, GPS coordinates for the PCD 100.

In the exemplary arrangement of FIG. 1, the monitor module 114 is in communication with multiple components or subsystems of PCD 100 such as PMIC 188 and PoP memory 112A. Notably, the exemplary embodiment is described using PMIC 188 and PoP memory 112A as illustrative of thermal energy generating or thermally sensitive components that may monitored for thermally aggressive behavior and/or may be throttled based on an estimated ambient temperature. The PMIC 188 and PoP memory 112A are not offered to imply or suggest that these particular components are the only components that may be monitored and/or throttled by a given embodiment.

In the exemplary FIG. 1 embodiment, the monitor module 114 monitors each of components PMIC 188 and PoP memory 112A and seeks to recognize when the components 188, 112A are indicating that PCD 100 is in an active state. Notably, one of ordinary skill in the art will recognize that the particular parameter or parameters monitored by the monitoring module 114 may differ depending on the particular component being monitored. For instance, in the case of the PMIC 188, the monitor module 114 may monitor current levels on a power rail to determine whether the battery 188 is being charged (which may be an indicator that the PCD 100 is not in an active state—i.e., recognition that there is no current on the power rail may be an active state qualifier). Similarly, in the case of the PoP memory 112A, the monitor module 114 may monitor read/write or migration activities to decide whether the PoP memory 112A component is active.

Based on the monitoring of the various parameters associated with one or more of the components 188 and 112A, the monitor module 114 may determine that the PCD 100 is in an active state and/or is generating significant amounts of thermal energy. In certain embodiments, the monitor module 114 may then activate the LI module 50 to begin gathering location information for estimating the ambient temperature. In some embodiments, the decision to begin gathering location information, or the frequency at which the location information is gathered, can depend on whether one or more of the components 188 and 112A are approaching a threshold for the parameters measured by the monitor module 114. One such parameter may be a thermal threshold value. In some embodiments, the LI module 50 may continuously gather location information at pre-determined time intervals, and the monitor module 114 may activate the LI module 50 to begin estimating the ambient temperature. In various embodiments, the monitor module 114 may activate the LI module 50 to increase or decrease the frequency of the location information gathering upon the monitor module 114 determining that the PCD 100 is in an active state.

The ambient temperature may be estimated by the LI module 50 based on the gathered location information, or may be estimated by the monitor module 114 based on information received from the LI module 50 as described below. The estimated ambient temperature may also be provided to the TPM module 101 which, in some embodiments, queries a temperature threshold lookup table (“LUT”) 25 to determine optimum temperature threshold settings for one or more components based on the estimated ambient temperature. For instance, as one of ordinary skill in the art would understand, if the estimated ambient temperature is significantly cooler than a previous estimation, the TPM module 101 may query the LUT 25 and determine that a temperature threshold associated with one or more components of the PCD 100 may be raised because the cooler ambient environment would be conducive to efficient thermal energy dissipation. In this manner, one or more components may be allowed to operate at a higher temperature threshold than they may otherwise operate without fear of thermal degradation, loss of QoS and/or damage to the component. Additionally, the touch temperature threshold of the PCD outer shell may also be raised because the ambient environment is cool enough to overcome any additional thermal energy that may be generated by processing components without detrimentally impacting QoS.

Raising the temperature threshold associated one or more components of the PCD 100, the TPM module 101 may result in various actions. For example raising the temperature threshold may authorize the DVFS module 26 to increase the processing speed of one or more of the cores 222, 224, 226 and 228 in CPU 110 when an ambient temperature estimate received by the TPM module 101 via monitor module 114 indicates that the ambient temperature is below a certain value. This certain value for the ambient temperature may be a previous estimation of the ambient temperature, or a pre-set assumption of ambient temperature for normal operations.

Conversely, if the estimated ambient temperature provided to the TPM module 101 from the monitor module 114 is significantly warmer than a previous estimation, or above an assumed ambient temperature for normal operations, the TPM module 101 may query LUT 25 and determine that the temperature thresholds for one or more of the cores 222, 224, 226, and 228 (or some other threshold) may be reduced because the warmer environment would preclude or inhibit efficient dissipation of thermal energy from the PCD 100.

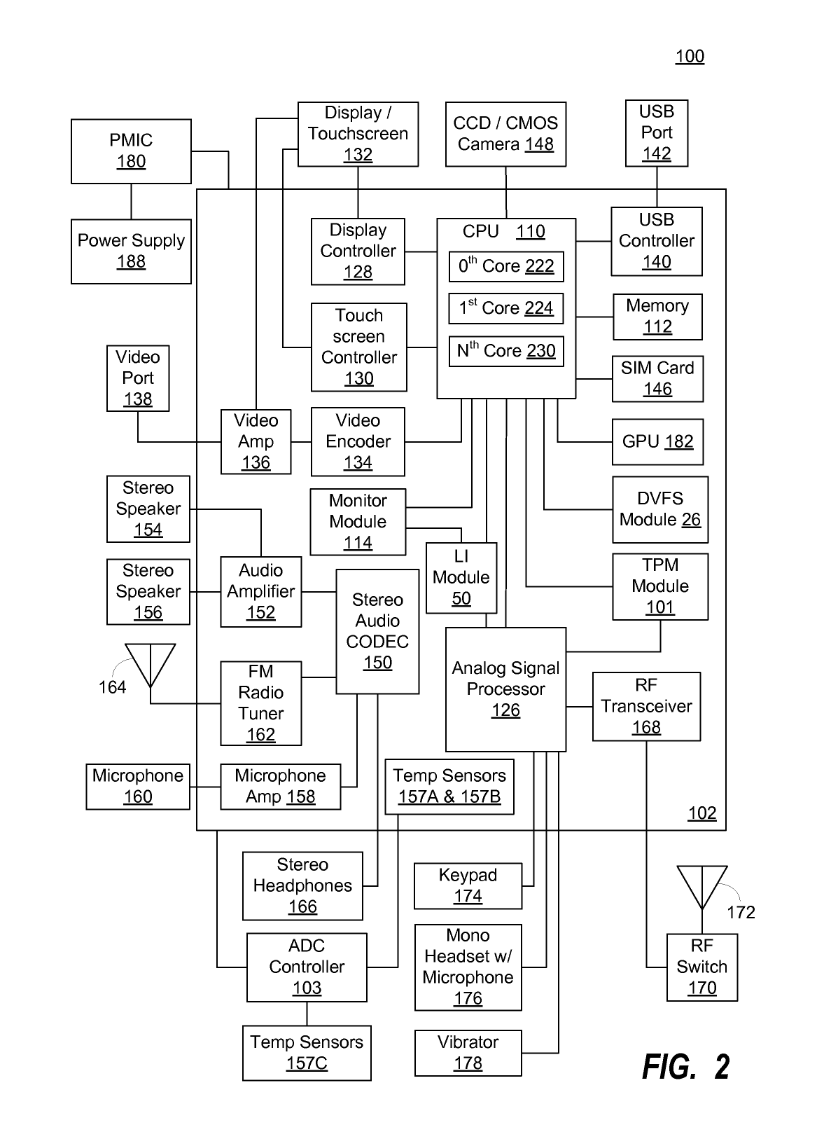

FIG. 2 is a functional block diagram illustrating an exemplary, non-limiting aspect of the PCD 100 of FIG. 1 in the form of a wireless telephone for implementing methods and systems for estimating environmental ambient temperature and using the estimation as an input to a thermal management technique. Notably, in certain embodiments, the PCD 100 may simply render an estimated ambient temperature on display 132. Additionally, the PCD 100 may in some embodiments use the estimated ambient temperature as an input to an application configured to provide functionality unrelated to optimization of processing performance.

As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, the dynamic voltage and frequency scaling (“DVFS”) module 26 may be responsible for implementing throttling techniques to individual processing components, such as cores 222, 224, 230 in an incremental fashion to help a PCD 100 optimize its power level and/or maintain a high level of functionality without detrimentally exceeding certain temperature thresholds.

The monitor module 114 communicates with multiple operational sensors (e.g., thermal sensors 157A, 157B) distributed throughout the on-chip system 102 and with the CPU 110 of the PCD 100 as well as with the TPM module 101. In some embodiments, monitor module 114 may also monitor skin temperature sensors 157C for temperature readings associated with a touch temperature of PCD 100. Further, the monitor module 114 may infer or estimate environmental ambient temperatures based on information received from LI module 50. Alternatively, LI module 50 may infer or estimate environmental ambient temperatures and provide the estimated ambient temperature value to the monitor module 114 or directly to the TPM module 101. The TPM module 101 may receive ambient temperature estimations from monitor module 114 (or directly from the LI 50). Additionally, the TPM module 101 may adjust the levels of acceptable temperature thresholds based on the ambient temperature estimations and operate with the monitor module 114 to identify temperature thresholds that have been exceeded. Further, the TPM module 101 may instruct the application of throttling strategies to identified components within chip 102 in an effort to reduce optimize performance and QoS. By recognizing changes in the estimated ambient temperature to which the PCD 100 is exposed, the TPM module 101 may optimize the QoS provided to a user. One example of such QoS optimization is determining the affect of the ambient temperature change on the overall ability of the PCD 100 to dissipate thermal energy and adjusting acceptable temperature thresholds of various processing components accordingly.

As illustrated in FIG. 2, a display controller 128 and a touch screen controller 130 are coupled to the digital signal processor 110. A touch screen display 132 external to the on-chip system 102 is coupled to the display controller 128 and the touch screen controller 130. PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core central processing unit (“CPU”) 110. A video amplifier 136 is coupled to the video encoder 134 and the touch screen display 132. A video port 138 is coupled to the video amplifier 136. As depicted in FIG. 2, a universal serial bus (“USB”) controller 140 is coupled to the CPU 110. Also, a USB port 142 is coupled to the USB controller 140. A memory 112 and a subscriber identity module (SIM) card 146 may also be coupled to the CPU 110. Further, as shown in FIG. 2, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 2, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 2 shows that a microphone amplifier 158 may also be coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 2 further indicates that a radio frequency (“RF”) transceiver 168 may be coupled to the analog signal processor 126. An RF switch 170 may be coupled to the RF transceiver 168 and an RF antenna 172. As shown in FIG. 2, a keypad 174 may be coupled to the analog signal processor 126. Also, a mono headset with a microphone 176 may be coupled to the analog signal processor 126. Further, a vibrator device 178 may be coupled to the analog signal processor 126. FIG. 2 also shows that a power supply 188, for example a battery, is coupled to the on-chip system 102 through PMIC 180. In a particular aspect, the power supply includes a rechargeable DC battery or a DC power supply that is derived from an alternating current (“AC”) to DC transformer that is connected to an AC power source.

In the exemplary embodiment illustrated in FIG. 2, one LI module 50 is shown coupled to the Analog Signal Processor 126, monitor module 114, and CPU 110. In this arrangement, the LI module 50 may seek, receive, or gather location information about the location of the PCD 100. In certain embodiments this PCD location information will include Global Positioning System (GPS) coordinates of the PCD and/or strength of the GPS signal. The PCD location information may also include weather information based on the PCD location, for example temperature information from the National Oceanic and Atmospheric Administration (NOAA) or other such sites for the GPS coordinates of the PCD 100. The PCD location information may also include information received from internet websites with temperature or other weather information based on the PCD location. Another example of PCD location information is information about the ambient temperature of the area surrounding the PCD, such as information from a vehicle in which the PCD 100 is located received via Bluetooth or other communications protocol. Yet another examples of PCD location information include ambient temperature information from a wi-fi or picocell device in communication with the PCD 100 and/or information from a building in which the PCD 100 is located (such as a smart home) received by Bluetooth or other communications protocol.

In some embodiments, the LI module 50 may be part of the monitor module 114, or the LI module 50 may be a separate element that is also directly in communication with the TPM module 101 (not shown). In additional embodiments, there may be multiple LI modules 50 (not shown) such as one LI module 50 as illustrated in FIG. 2, with another LI module 50′ in communication with the USB port 142 or USB controller 140. In this manner, the LI module 50′ may query for and/or receive location information through a USB connection to the PCD 100 instead of, or in addition to, information received from radio communications with the PCD 100.

The CPU 110 may also be coupled to one or more internal, on-chip thermal sensors 157A, 157B as well as one or more external, off-chip thermal sensors 157C. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157C may comprise one or more thermistors. The thermal sensors 157C may produce a voltage drop that is converted to digital signals with an analog-to-digital converter (“ADC”) controller 103. However, other types of thermal sensors 157A, 157B, 157C may be employed without departing from the scope of the invention.

The DVFS module(s) 26, TPM module(s) 101, monitor module 114, and/or LI module(s) 50 may comprise software which is executed by the CPU 110. However, the DVFS module(s) 26, TPM module(s) 101, monitor module 114, and/or LI module(s) 50 may also be formed from hardware and/or firmware without departing from the scope of the invention. The TPM module(s) 101 in conjunction with the DVFS module(s) 26 may be responsible for applying throttling policies that may help a PCD 100 avoid thermal degradation while maintaining a high level of functionality and user experience.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, the power supply 188, the PMIC 180 and the thermal sensors 157C are external to the on-chip system 102. However, it should be understood that the monitor module 114 may also receive one or more indications or signals from one or more of these external devices by way of the analog signal processor 126 and the CPU 110 to aid in the real time management of the resources operable on the PCD 100.

In a particular aspect, one or more of the method steps described herein may be implemented by executable instructions and parameters stored in a memory 112 that may form one or more of the TPM module(s) 101, monitor module(s) 114, LI module(s) 50, and DVFS module(s) 26. These instructions that form the module(s) 101, 114, 50, 26 may be executed by the CPU 110, the analog signal processor 126, or another processor, in addition to the ADC controller 103 to perform the methods described herein. Further, the processors 110, 126, the memory 112, the instructions stored therein, or a combination thereof may serve as a means for performing one or more of the method steps described herein.

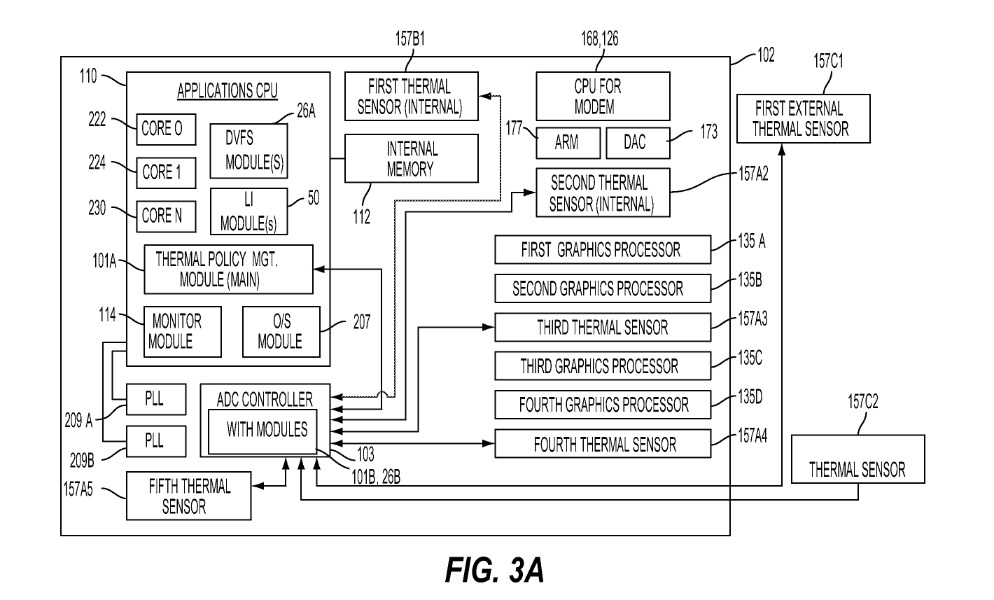

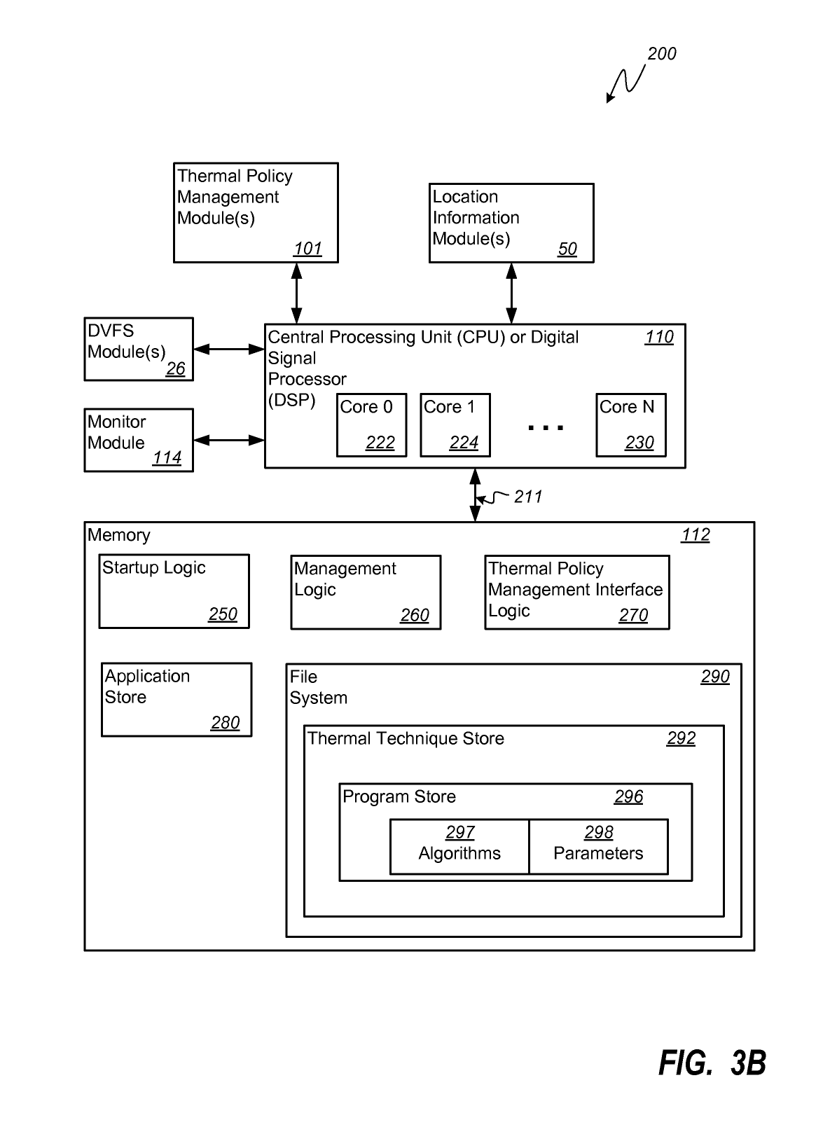

FIG. 3A is a functional block diagram illustrating an exemplary spatial arrangement of hardware for the chip 102 illustrated in FIG. 2. According to this exemplary embodiment, the applications CPU 110 is positioned on the far left side region of the chip 102 while the modem CPU 168, 126 is positioned on a far right side region of the chip 102. The applications CPU 110 may comprise a multi-core processor that includes a zeroth core 222, a first core 224, and an Nth core 230. The applications CPU 110 may be executing a TPM module 101A, DVFS module 26A, monitor module 114, and/or LI module 50 (when embodied in software) or it may include a TPM module 101A, DVFS module 26A, monitor module 114, and/or LI module 50 (when embodied in hardware). The application CPU 110 is further illustrated to include operating system (“O/S”) module 207. Further details about the monitor module 114 will be described below in connection with FIG. 3B.

The applications CPU 110 may be coupled to one or more phase locked loops (“PLLs”) 209A, 209B, which are positioned adjacent to the applications CPU 110 and in the left side region of the chip 102. Adjacent to the PLLs 209A, 209B and below the applications CPU 110 may comprise an analog-to-digital (“ADC”) controller 103 that may include its own TPM module 101B, monitor module 114B, and/or DVFS module 26B that works in conjunction with the main modules 101A, 114, 26A of the applications CPU 110.

The monitor module 114B of the ADC controller 103 may be responsible for monitoring and tracking multiple thermal sensors 157 that may be provided “on-chip” 102 and “off-chip” 102. The on-chip or internal thermal sensors 157A, 157B may be positioned at various locations and associated with thermal aggressor(s) proximal to the locations (such as with sensor 157A3 next to second and third thermal graphics processors 135B and 135C) or temperature sensitive components (such as with sensor 157B1 next to memory 112). The monitor module 114B may also be responsible for monitoring and recognizing various parameters associated with components of PCD 100 that indicate an active state.

As a non-limiting example, a first internal thermal sensor 157B1 may be positioned in a top center region of the chip 102 between the applications CPU 110 and the modem CPU 168,126 and adjacent to internal memory 112. A second internal thermal sensor 157A2 may be positioned below the modem CPU 168, 126 on a right side region of the chip 102. This second internal thermal sensor 157A2 may also be positioned between an advanced reduced instruction set computer (“RISC”) instruction set machine (“ARM”) 177 and a first graphics processor 135A. A digital-to-analog controller (“DAC”) 173 may be positioned between the second internal thermal sensor 157A2 and the modem CPU 168, 126.

A third internal thermal sensor 157A3 may be positioned between a second graphics processor 135B and a third graphics processor 135C in a far right region of the chip 102. A fourth internal thermal sensor 157A4 may be positioned in a far right region of the chip 102 and beneath a fourth graphics processor 135D. And a fifth internal thermal sensor 157A5 may be positioned in a far left region of the chip 102 and adjacent to the PLLs 209 and ADC controller 103.

One or more external thermal sensors 157C may also be coupled to the ADC controller 103. The first external thermal sensor 157C1 may be positioned off-chip and adjacent to a top right quadrant of the chip 102 that may include the modem CPU 168, 126, the ARM 177, and DAC 173. A second external thermal sensor 157C2 may be positioned off-chip and adjacent to a lower right quadrant of the chip 102 that may include the third and fourth graphics processors 135C, 135D. Notably, one or more of external thermal sensors 157C may be leveraged to indicate the touch temperature of the PCD 100, i.e. the temperature that may be experienced by a user in contact with the PCD 100.

One of ordinary skill in the art will recognize that various other spatial arrangements of the hardware illustrated in FIG. 3A may be provided without departing from the scope of the invention. FIG. 3A illustrates one exemplary spatial arrangement for the main TPM, monitor module, LI module 50, and DVFS module 101A, 114, 50, 26A and ADC controller 103 with its TPM, monitor module and DVFS module 101B, 114B, 26B. These modules may be used to recognize entry of the PCD 100 into an active state and monitor thermal conditions that are a function of the exemplary spatial arrangement illustrated in FIG. 3A. Additionally, these exemplary modules shown in FIG. 3A may operate to estimate an environmental ambient temperature based on the information gathered by the LI module 50 and adjust temperature thresholds based on the estimated ambient temperature. Further, based on the estimated ambient temperature, throttling strategies may be applied to one or more components, subsystems or portions of the PCD 100.

FIG. 3B is a schematic diagram illustrating an exemplary software architecture of the PCD 100 of FIG. 2. In the exemplary software architecture of FIG. 3B the environmental ambient temperature may be estimated from information gathered by LI module(s) 50. The estimated ambient temperature may be used as an input to one or more thermal management policy or thermal management technique. Any number of algorithms may form or be part of at least one thermal management policy that may be applied by the TPM module 101 when certain thermal conditions are met. In a preferred embodiment the TPM module 101 works with the DVFS module 26 to incrementally apply voltage and frequency scaling policies to individual thermal aggressors in chip 102 including, but not limited to, cores 222, 224 and 230.

As illustrated in FIG. 3B, the CPU or digital signal processor 110 is coupled to the memory 112 via a bus 211. The CPU 110, as noted above, is a multiple-core processor having N core processors. That is, the CPU 110 includes a first core 222, a second core 224, and an N^{th} core 230. As is known to one of ordinary skill in the art, each of the first core 222, the second core 224 and the N^{th} core 230 are available for supporting a dedicated application or program. Alternatively, one or more applications or programs can be distributed for processing across two or more of the available cores.

The CPU 110 may receive commands from the TPM module(s) 101, monitor module 114, LI module(s) 50, and/or DVFS module(s) 26 that may comprise software and/or hardware. If embodied as software, the module(s) 101, 114, 50, 26 comprise instructions that are executed by the CPU 110 that issues commands to other application programs being executed by the CPU 110 and other processors.

The first core 222, the second core 224 through to the Nth core 230 of the CPU 110 may be integrated on a single integrated circuit die, or they may be integrated or coupled on separate dies in a multiple-circuit package. Designers may couple the first core 222, the second core 224 through to the N^{th} core 230 via one or more shared caches and they may implement message or instruction passing via network topologies such as bus, ring, mesh and crossbar topologies.

Bus 211 may include multiple communication paths via one or more wired or wireless connections, as is known in the art. The bus 211 may have additional elements, which are omitted for simplicity, such as controllers, buffers (caches), drivers, repeaters, and receivers, to enable communications. Further, the bus 211 may include address, control, and/or data connections to enable appropriate communications among the aforementioned components.

When the logic used by the PCD 100 is implemented in software, as is shown in FIG. 3B, it should be noted that one or more of startup logic 250, management logic 260, thermal policy management interface logic 270, applications in application store 280 and portions of the file system 290 may be stored on any computer-readable medium for use by, or in connection with, any computer-related system or method.

In the context of this document, a computer-readable medium is an electronic, magnetic, optical, or other physical device or means that can contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where one or more of the startup logic 250, management logic 260 and perhaps the thermal policy management interface logic 270 are implemented in hardware, the various logic may be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The memory 112 is a non-volatile data storage device such as a flash memory or a solid-state memory device. Although depicted as a single device, the memory 112 may be a distributed memory device with separate data stores coupled to the digital signal processor 110 (or additional processor cores).

The startup logic 250 includes one or more executable instructions for selectively identifying, loading, and executing a select program for managing or controlling the performance of one or more of the available cores such as the first core 222, the second core 224 through to the N^{th} core 230. The startup logic 250 may identify, load and execute a select program based on the adjustment by the TPM module 101 of threshold temperature settings associated with a PCD component or aspect based on receipt of an estimated ambient temperature. An exemplary select program can be found in the program store 296 of the embedded file system 290 and is defined by a specific combination of a performance scaling algorithm 297 and a set of parameters 298. The exemplary select program, when executed by one or more of the core processors in the CPU 110 may operate in accordance with one or more signals provided by the monitor module 114 in combination with control signals provided by the one or more TPM module(s) 101, LI module(s) 50, and DVFS module(s) 26 to scale the performance of the respective processor core “up” or “down.”

The management logic 260 includes one or more executable instructions for terminating a thermal management program on one or more of the respective processor cores, as well as selectively identifying, loading, and executing a more suitable replacement program for managing or controlling the performance of one or more of the available cores. The management logic 260 is arranged to perform these functions at run time or while the PCD 100 is powered and in use by an operator of the device. A replacement program can be found in the program store 296 of the embedded file system 290 and, in some embodiments, may be defined by a specific combination of a performance scaling algorithm 297 and a set of parameters 298.

The replacement program, when executed by one or more of the core processors in the digital signal processor 110 may operate in accordance with one or more signals provided by the monitor module 114 and/or LI module(s) 50, or one or more signals provided on the respective control inputs of the various processor cores to scale the performance of the respective processor core. In this regard, the monitor module 114 may provide one or more indicators of events, processes, applications, resource status conditions, elapsed time, temperature, etc. in response to control signals originating from the TPM 101.

The interface logic 270 includes one or more executable instructions for presenting, managing and interacting with external inputs to observe, configure, or otherwise update information stored in the embedded file system 290. In one embodiment, the interface logic 270 may operate in conjunction with manufacturer inputs received via the USB port 142. These inputs may include one or more programs to be deleted from or added to the program store 296. Alternatively, the inputs may include edits or changes to one or more of the programs in the program store 296. Moreover, the inputs may identify one or more changes to, or entire replacements of one or both of the startup logic 250 and the management logic 260. By way of example, the inputs may include a change to the management logic 260 that instructs the PCD 100 to suspend all performance scaling in the RF transceiver 168 when the received signal power falls below an identified threshold. By way of further example, the inputs may include a change to the management logic 260 that instructs the PCD 100 to apply a desired program when the video codec 134 is active.

The interface logic 270 enables a manufacturer to controllably configure and adjust an end user's experience under defined operating conditions on the PCD 100. When the memory 112 is a flash memory, one or more of the startup logic 250, the management logic 260, the interface logic 270, the application programs in the application store 280 or information in the embedded file system 290 can be edited, replaced, or otherwise modified. In some embodiments, the interface logic 270 may permit an end user or operator of the PCD 100 to search, locate, modify or replace the startup logic 250, the management logic 260, applications in the application store 280 and information in the embedded file system 290. The operator may use the resulting interface to make changes that will be implemented upon the next startup of the PCD 100. Alternatively, the operator may use the resulting interface to make changes that are implemented during run time.

The embedded file system 290 includes a hierarchically arranged thermal technique store 292. In this regard, the file system 290 may include a reserved section of its total file system capacity for the storage of information for the configuration and management of the various parameters 298 and thermal management algorithms 297 used by the PCD 100. As shown in FIG. 3B, the store 292 includes a program store 296, which includes one or more thermal management programs.

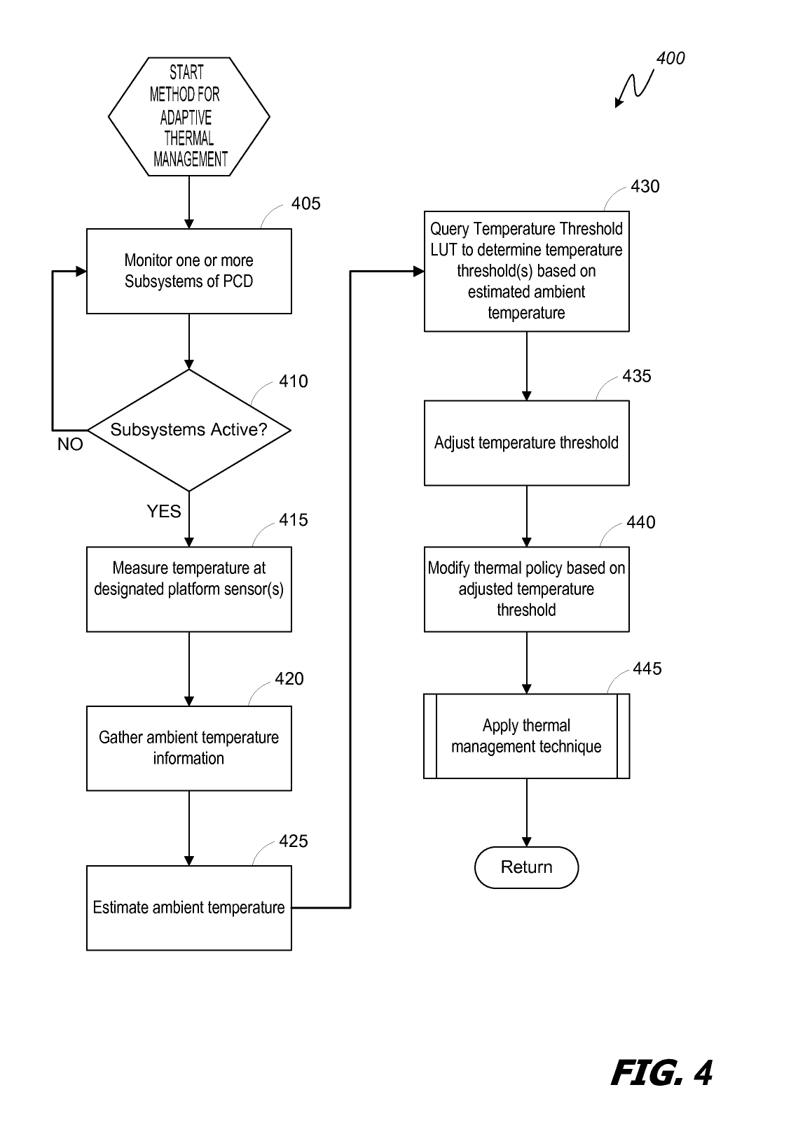

FIG. 4 is a logical flowchart illustrating a method 400 for estimating environmental ambient temperature from PCD location information for the PCD 100 of FIG. 1 and using the estimation as an input to a thermal management technique. Exemplary method 400 of FIG. 4 starts with a first block 405 where a monitor module 114 monitors one or more components or subsystems within PCD 100 for activity identifiers. Any number of parameters associated with the various monitored subsystems may be monitored by the monitor module in an effort to identify an overall active state of the PCD 100. For instance, current levels, voltage levels, temperature, frequencies, etc. may be monitored to determine the activity level of any one or more subsystems. As described above, in preferred embodiments the monitored components may be generally unrelated in functionality so that recognition of activity in each of the components serves as an accurate predictor of an overall active state of the PCD 100.

At decision block 410, if the various subsystems are determined to be inactive, the “no” branch is followed back to block 405 and monitoring of the subsystems continues. If at decision block 410, the activity levels of the monitored subsystems is determined to meet the requirements of a predefined active state qualifier, i.e. the monitored parameters associated with each monitored subsystem indicates that one or more of (or a predetermined number or combination of) the systems are active, then the PCD 100 is assumed to be in an active state that represents a relatively high level of thermal energy generation and the “yes” branch is followed to block 415.

At block 415, temperature readings may be taken from various temperature sensors 157 within the PCD 100. As one of ordinary skill in the art would understand, when processing components within the PCD 100 are actively processing workloads, the temperature readings taken from the various temperature sensors 157 may indicate operating temperatures of the processing components with which each is associated. However, when the PCD 100 is determined to be in an active state, in which the processing burdens of the processing components are light or negligible, the temperature readings taken from the same sensors may be useful for estimating the ambient temperature of the environment to which the entire PCD 100 is exposed. In other embodiments, the method 400 will measure the temperature at designated platform sensor(s) as part of the monitoring of one or more subsystems of the PCD 100 that is performed in block 405. In such embodiments, the temperature readings obtained may be used when making the decision at block 410 as to whether there is an active state qualifier. In yet other embodiments, the temperature measurements of block 415 may not take place until later in the method 400, such as after the ambient temperature is estimated (see discussion of block 425 below).

At block 420, some embodiments of the systems and methods will begin gathering ambient temperature information for the PCD 100. In other embodiments, the method and system will have been already collecting the ambient temperature information for the PCD 100 (such as for example whenever GPS information is obtained by the PCD 100). In such embodiments, block 420 may result in the most recent ambient temperature information being used to estimate an ambient temperature (see block 425) and/or being forwarded to other components or modules of the system.

Additionally, in embodiments when ambient temperature information is already being periodically collected, block 415 may result in a change (either increase or decrease) in the frequency that such ambient temperature information is gathered and/or forwarded to other components of modules of the system. For example, in circumstances when it is determined that one or more components, subsystems, and/or cores are within a certain range of a maximum operating temperature, block 420 may result in more frequent gathering of ambient temperature information. In other circumstances, such as when only a few components, subsystems, or cores are in an active state and/or the trend in the temperature trend for the thermally active components is decreasing, block 420 may result in a less frequent gathering of ambient temperature information.

It is envisioned that in certain embodiments, the LI module 50 will gather the ambient temperature information. In other embodiments, the LI module 50 may not be a separate component or software, but instead, the functionality of the LI module 50 may be included within one or more of the other components or software of the system or method, such as the monitor module 114 and/or TPM module 101.

The ambient temperature information gathered is envisioned to comprise information based at least in part on the location of the PCD 100. Examples of such PCD location information include the GPS coordinates of the PCD 100 and/or strength of the GPS signal received by the PCD 100. Other examples of PCD location information include temperature information based on the PCD location, such as for example temperature information from the National Oceanic and Atmospheric Administration (NOAA) or other such sites for the GPS coordinates of the PCD 100. PCD information may also include information received from internet websites with temperature or other relevant information based on the PCD location. Such relevant other information may include additional weather information or information about the time of day and/or month of the year based on GPS coordinates. Such relevant other information may also include information from mapping websites such as Google Maps that would indicate that the PCD 100 was indoors.

Additional sources of PCD location information may include information from a vehicle in which the PCD 100 is located received via Bluetooth, near field communication (NFC), or other communications protocol. Such information could include the strength of the Bluetooth signal that may indicate the PCD 100 is in a vehicle. Additionally, such information could include ambient temperature information known to or generated by the vehicle, such as from ambient temperature sensors located in or on the vehicle.

Yet other sources of PCD location information may include information from a wireless device, wi-fi device, and/or picocell in communication with the PCD 100 that indicate that the PCD 100 is indoors. Such information may include the presence of and/or strength of one or more wireless router or picocell signals which may be used to triangulate the location of the PCD 100. Additionally, such information may include ambient temperature information known to or generated by a wireless router or a picocell, such as from ambient temperature sensors located in, or in communication with, the wireless router or picocell.

Another source of PCD location information may include information from a building or dwelling in which the PCD 100 is located (such as a smart home) that is received by the PCD 100 via Bluetooth or other communications protocol. Such information may be used to either directly determine the ambient temperature or to determine that the PCD 100 is currently located indoors.

Returning to the method 400, once the available ambient temperature information has been gathered, an ambient temperature for the PCD 100 is estimated at block 425. In some embodiments, the LI module 50 estimates the ambient temperature. In other embodiments, the LI module 50 forwards some, or all, of the ambient temperature information to another component or module, such as the monitor module 114, and that other component or module performs the estimation.

It is envisioned that various algorithms, formulas, and/or processes may be used to estimate the ambient temperature in block 425, depending on the amount and types of ambient temperature available. Additionally, it is envisioned that in various embodiments some or all of the ambient temperature information may be used in combination when performing the estimation of the ambient temperature in block 425.

For instance, in some embodiments, when GPS information about the location of the PCD 100 is available the LI module 50 (or some other portion of the PCD 100) may query various websites to determine if weather information such as temperature, season, humidity, etc., is available for those GPS coordinates. The estimation of the ambient temperature in such circumstances may also evaluate the strength of the GPS signal and/or loss of GPS signal tracking, or determine whether one or more picocell or wireless router signals are being received by the PCD 100.

In one example, GPS signal strength may be used as part of the estimation in that GPS signal strength typically drops and/or GPS signal tracking may fail when a use is indoors. A drop in GPS signal strength for a period of time, or a measured loss of GPS tracking over a period of time may be used to estimate that the PCD 100 is indoors. In other examples, the estimation of the ambient temperature may also query other websites, such as mapping websites to try and determine whether the PCD 100 is indoors or outdoors at the particular GPS coordinates.

Similarly, the estimation of the ambient temperature may include in some embodiments, a determination of whether or not the GPS coordinates for the PCD 100 are changing to see if the PCD 100 is moving. For such embodiments, the estimation may determine how quickly the GPS coordinates are changing and/or the presence of a Bluetooth signal to determine whether the PCD 100 is being transported in a car. As can be appreciated a determination that the PCD 100 is being transported in a car may cause the estimation to assume standard indoor temperatures. On the other hand, a determination that the PCD 100 is moving, but is not in a car may indicate that the PCD 100 is being transported by an individual walking, bicycling or riding a motorcycle which may indicate an outdoors ambient temperature).

In certain embodiments, it is envisioned that the LI module 50, or other component of the PCD 100 may be able to obtain specific ambient temperature information from wireless devises and/or picocells in communication with the PCD 100. In such embodiments, the PCD 100 may, by using WLAN, WiFi, or other communication technique, identify a wireless device or picocell in communication with the PCD 100 to indicate that the PCD 100 is indoors. Such wireless device or picocell may in some embodiments be able to directly determine the ambient temperature. For instance, such wireless device or picocell may be configured with temperature sensors to measure the ambient temperature of a building where the PCD 100 may be located (including for instance for houses configured with Smarthome-type controls that may be used to control the temperature of the house and/or may contain a local temperature database). Similarly, it is envisioned that the LI module 50, or other component of the PCD 100, may also be able to obtain specific ambient temperature information from automobiles, such as from a Bluetooth communication with the automobile.

In some embodiments, the estimation of the ambient temperature at block 425 may include algorithms or ways to provide different weight to different types of available ambient temperature information and/or to assign a confidence level to the estimated ambient temperature information. For example, different sources of ambient temperature information may be ranked by confidence level, and an estimated ambient temperature will only be used by the following steps of the method 400 if a certain type or number of “high confidence” sources are available for the ambient temperature estimation. In other examples, the different sources or types of ambient temperature information may be provided a lesser or greater weight, such that the ambient temperature estimate is a weighted average of the various ambient temperature information. As will be appreciated by one of skill in the art, there are other ways that a confidence level for, or a weighted estimation of, the ambient temperature may be generated. Accordingly, the scope of this disclosure and the embodiments described herein will not be limited to include just the few sample discussed above.

Continuing with the method 400, at block 430, a temperature threshold lookup table 25 may be queried based on the estimated ambient temperature to determine an optimum temperature threshold setting for one or more components, subsystems, and/or cores of the PCD 100. Notably, it is envisioned that threshold settings other than temperature may also be adjusted in some embodiments based on the estimated ambient temperature. Accordingly, the scope of this disclosure and the embodiments described herein will not be limited to include adjustment of temperature thresholds. Similarly, it is also envisioned that threshold settings for multiple components or portions of the PCD 100 may be set or adjusted based on the estimated ambient temperature, including, but not limited to, a threshold for the skin temperature of the PCD 100. Again, the scope of this disclosure and the embodiments described herein will not be limited to include adjustment of thresholds for only the cores or components of the PCD 100 specifically addressed herein in exemplary embodiments.

At block 435, the temperature threshold (or other threshold) is adjusted based on the LUT 25 query. Note that in embodiments where a confidence level is assigned to or calculated for the estimated ambient temperature at an earlier step of the method 400 (such as in block 425), block 435 may only adjust the temperature threshold (or other threshold) in those circumstances where the estimated ambient temperature has a certain confidence level or confidence level value. Alternatively, in certain embodiments, the amount the temperature threshold (or other threshold) is adjusted in block 435 may depend or vary in accordance with the confidence level or confidence level value assigned to or determined for the estimated ambient temperature.

As described above, the temperature threshold (or other threshold) may be adjusted upward, thereby providing additional thermal energy generating headroom for one or more processing components, when the estimated ambient temperature is cooler than a previous estimation or is below a certain value. Similarly, the temperature threshold may be adjusted downward, thereby reducing the amount of thermal energy that may be generated by one or more processing components, when the estimated ambient temperature is hotter than a previous estimation or above a certain value.

At block 440, the thermal policy may be modified based on the adjusted temperature threshold (or other threshold) such that at block 445 a thermal management technique for managing the thermal energy produced by one or more processing components (or other components) is applied based on the adjusted temperature threshold as an input. For instance, with an increased temperature threshold at block 440, the thermal management technique applied at block 445 may increase the processing speed of one or more processing components within PCD 100, thereby increasing the QoS provided to a user of PCD 100. Similarly, with a decreased temperature threshold at block 440, the thermal management technique applied at block 445 may reduce the processing speed of one or more processing components within PCD 100, thereby optimizing the QoS provided to a user of PCD 100 while securing the health of the PCD 100 and/or preventing damage to the processing components within the PCD 100.

Advantageously, the ambient temperature of the PCD 100, as estimated in the previous steps of the method 400, can be used to better and/or more accurately implement thermal policies for the PCD 100 and/or specific components, subsystems, and cores of the PCD 100. This may allow for instance, a more accurate calculation of the power reductions (or other mitigation measures) that may be needed to perform thermal mitigation to optimize the QoS. For example, if the measurement of the temperature at designated platform sensors at block 415 indicates that a particular thermal aggressor is operating above a temperature threshold for efficient operation, the thermal management technique in block 445 may be applied to that particular thermal aggressor. In such an instance, block 445 and may better determine the appropriate thermal management technique, based on the ambient temperature as estimated earlier in the method 400. Such appropriate thermal management techniques may include more accurately calculating the level of power reduction to bring the thermal aggressor back into a recommended range, or allowing the thermal aggressor to operate at the higher than recommended temperature.

FIG. 5 is a logical flowchart illustrating an exemplary sub-method or subroutine 445 for applying dynamic voltage and frequency scaling (“DVFS”) thermal mitigation techniques that use temperature thresholds adjusted based on an estimated environmental ambient temperature. In certain embodiments, the DVFS throttling techniques may be applied to individual processing components to manage thermal energy generation within temperature thresholds.

As understood by one of ordinary skill in the art, the demand for processors that provide high performance and low power consumption has led to the use of various power management techniques, such as, dynamic voltage and frequency scaling, sometimes referred to as dynamic voltage and current scaling (“DVCS”), in processor designs. DVFS enables trade-offs between power consumption and performance. Processors 110 and 126, for instance, may be designed to take advantage of DVFS by allowing the clock frequency of each processor to be adjusted with a corresponding adjustment in voltage. A reduction in operating voltage usually results in a proportional savings in power consumed and thermal energy generated. One issue for DVFS enabled processors 110, 126 is how to control the balance between performance and power savings.

Block 505 is the first step in the subroutine 450 for applying DVFS thermal mitigation techniques in a thermal management framework that includes adjustable temperature thresholds. In this first block 505, the TPM module 101 may determine that a temperature threshold, such as a skin temperature threshold, may be adjusted based on an estimation of the ambient temperature of the environment in which the PCD 100 resides. Accordingly, the TPM module 101 may initiate instructions to the DVFS module 26 to review the current DVFS settings in block 510.

Next, in block 515, the DVFS module 26 may determine that the power level of the processing component can be reduced or increased, as the adjusted temperature threshold(s) may dictate or allow. In doing so, the DVFS module 26 may adjust or issue commands to incrementally adjust the current DVFS settings that may include voltage and/or frequency, in order to manage thermal loading conditions. Adjusting the settings may comprise adjusting or “scaling” the maximum clock frequency allowed in DVFS algorithm. Notably, although the monitor module 114, TPM module 101 and DVFS module 26 have been described in the present disclosure as separate modules with separate functionality, it will be understood that in some embodiments the various modules, or aspects of the various modules, may be combined into a common module for implementing adaptive thermal management policies.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for tuning a thermal strategy of a portable computing device (“PCD”) from location information about the PCD, the method comprising:
monitoring a parameter associated with one or more subsystems of the PCD, wherein a parameter indicates an activity level of at least one component of the PCD with which the parameter is associated;
receiving location information about the PCD;
based on the received location information, estimating the environmental ambient temperature of the PCD; and
based on the estimated environmental ambient temperature, adjusting a temperature threshold associated with the PCD.

2. The method of claim 1, wherein the received location information includes Global Positioning System (“GPS”) information about the PCD.

3. The method of claim 2, wherein the GPS information about the PCD further includes the strength of the signal for the GPS information.

4. The method of claim 2, wherein the GPS information about the PCD further includes weather information based on the GPS information.

5. The method of claim 2, wherein the GPS information about the PCD further includes information to determine whether the PCD is inside a building.

6. The method of claim 1, wherein the received location information includes one or more radio signals received by the PCD, and wherein estimating the environmental ambient temperature of the PCD further includes determining whether the PCD is inside of a building based on the one or more radio signals.

7. The method of claim 1, wherein the temperature threshold is associated with the at least one component of the PCD.

8. The method of claim 7, wherein the temperature threshold is increased.

9. The method of claim 8, further comprising:
increasing the processing speed of one or more processing components of the at least one component of the PCD.

10. The method of claim 7, wherein the temperature threshold is decreased.

11. The method of claim 10, further comprising:
decreasing the processing speed of one or more processing components of the at least one component of the PCD.

12. A computer system for tuning a thermal strategy of a portable computing device (“PCD”) from location information about the PCD, the system comprising:
a monitor module configured to:
monitor a parameter associated with each of one or more components of the PCD, wherein the parameter indicates an activity level of the component with which the parameter is associated;
a location information (“LI”) module configured to:
receive location information about the PCD;
based on the received location information, estimate the environmental ambient temperature of the PCD; and
a thermal policy management (“TPM”) module configured to:
based on the estimated environmental ambient temperature, adjust a temperature threshold associated with the PCD.

13. The computer system of claim 12, wherein the monitor module is further configured to:
measure the temperature at designated platform sensors in the PCD.

14. The computer system of claim 12, wherein the monitor module is further configured to:
determine whether any of the one or more components of the PCD is approaching a temperature threshold for the one or more components.

15. The computer system of claim 14, wherein the monitor module is further configured to:
cause the LI module to change the frequency at which the LI module receives location information about the PCD based on the determination whether any of the one or more components of the PCD is approaching a temperature threshold for the one or more components.

16. The computer system of claim 11, wherein the temperature threshold is associated with one of the one or more components of the PCD.

17. The computer system of claim 16, wherein the temperature threshold is increased.

18. The computer system of claim 17, further comprising:
a dynamic voltage and frequency scaling (“DVFS”) module configured to:
increase the processing speed of a processing component of the one or more components of the PCD.

19. The computer system of claim 16, wherein the temperature threshold is decreased.

20. The computer system of claim 19, further comprising:
a dynamic voltage and frequency scaling (“DVFS”) module configured to:
decrease the processing speed of a processing component of the one or more components of the PCD.

21. A computer system for tuning a thermal strategy of a portable computing device (“PCD”) from location information about the PCD, the system comprising:
means for monitoring a parameter associated with each of one or more components of the PCD, wherein the parameter indicates an activity level of the component with which the parameter is associated;
means for receiving location information about the PCD;
based on the received location information, estimating the environmental ambient temperature of the PCD; and
means for adjusting a temperature threshold associated with the PCD based on the estimated environmental ambient temperature.

22. The computer system of claim 21, wherein the received location information includes GPS-based information about the PCD.

23. The computer system of claim 21, further comprising:
means for rendering an indication of the estimated environmental ambient temperature.

24. The computer system of claim 21, further comprising:
means for determining whether any of the one or more components of the PCD is approaching a temperature threshold for the one or more components.

25. The computer system of claim 24, further comprising:
means for causing the LI module to change the frequency at which the LI module receives location information about the PCD based on the determination whether any of the one or more components of the PCD is approaching a temperature threshold for the one or more components.

26. The computer system of claim 21, wherein the temperature threshold is associated with the at least one component of the PCD.

27. The computer system of claim 26, wherein the temperature threshold is increased.

28. The computer system of claim 27, further comprising:
means for increasing the processing speed of a processing component of the at least one component of the PCD.

29. The computer system of claim 26, wherein the temperature threshold is decreased.

30. The computer system of claim 29, further comprising:
means for decreasing the processing speed of a processing component of the at least one component of the PCD.

31. A computer program product comprising a computer usable medium having a computer readable program code embodied therein, said computer readable program code adapted to be executed to implement a method for tuning a thermal strategy of a portable computing device (“PCD”) from location information about the PCD, said method comprising:
monitoring a parameter associated with one or more subsystems of the PCD, wherein a parameter indicates an activity level of at least one component of the PCD with which the parameter is associated;
receiving location information about the PCD;
based on the received location information, estimating the environmental ambient temperature of the PCD; and
based on the estimated environmental ambient temperature, adjusting a temperature threshold associated with the PCD.

32. The computer program product of claim 31, wherein the received location information includes GPS information about the PCD.

33. The computer program product of claim 32, wherein the GPS information about the PCD further includes the strength of the signal for the GPS information.

34. The computer program product of claim 32, wherein the GPS information about the PCD further includes weather information based on the GPS information.

35. The computer program product of claim 31, wherein the received location information includes one or more radio signals received by the PCD, and wherein estimating the environmental ambient temperature of the PCD further includes determining whether the PCD is inside of a building based on the one or more radio signals.

36. The computer program product of claim 31, wherein the temperature threshold is associated with the at least one component of the PCD.

37. The computer program product of claim 36, wherein the temperature threshold is increased.

38. The computer program product of claim 37, further comprising:
increasing the processing speed of a processing component of the at least one component of the PCD.

39. The computer program product of claim 37, wherein the temperature threshold is decreased.

40. The computer program product of claim 39, further comprising:
decreasing the processing speed of a processing component of the at least one component of the PCD.
